(19) United States
(12) Patent Application Publication
(10) Pub. No.: US 2007/0162735 A1
(43) Pub. Date: Jul. 12, 2007

(54) Control chip for a computer boot procedure and related method

(75) Inventor: Shu-Ching Cho, Taipei Hsien (TW)

Correspondence Address: BACON & THOMAS, PLLC, 625 SLATERS LANE, FOURTH FLOOR, ALEXANDRIA, VA, 22314, US

(73) Assignee: Wistron Corporation, Taipei Hsien (TW)

(21) Appl. No.: 11/436,669

(22) Filed: May 19, 2006

(30) Foreign Application Priority Data
Jan. 9, 2006 (TW) 095100792

(51) Int. Cl. G06F 15/177

(52) U.S. Cl. 713/2

(57) ABSTRACT

A control chip for a boot procedure comprises a first boot program and a second boot program. Under normal conditions, the first boot program is executed to power-on a system. Under abnormal conditions, for example, when the first boot program needs to be updated or has been corrupted by a previous firmware update procedure, the second boot program is executed to update the first boot program.

### BACKGROUND OF THE INVENTION

1. Field of the Invention

The present invention relates to a control chip for a computer boot procedure, and more particularly to a keyboard control chip (KBC) with a first boot program and a second boot program and related method.

2. Description of the Related Art

Keyboard control chips for notebook computers, and some desktop computers, are used for controlling the keyboard and for booting the computing device by way of a coded boot program. When manufacturing the computer system, it may sometimes be necessary to update or repair the boot program; the only solution for this is to replace the entire keyboard control chip with an updated keyboard control chip, which increases manufacturing costs and complexity.

To solve the above problem, a prior art technique utilizes a hardware switch on the motherboard to control hardware pins (such as KBC GPIO pins) of the keyboard control chip to control a boot area. However, as more and more functions are added into keyboard control chips, less and less hardware pins are available. Additionally, this technique leads to increases in material costs and a shortage of hardware pins.

### SUMMARY OF THE INVENTION

An object of the present invention is to provide a control chip for a boot procedure that comprises a first boot program and a second boot program, the second boot program executable under anomalous conditions.

Another object of the present invention is to provide a control chip for a boot procedure that is able to execute a anomalous-condition boot procedure.

To achieve these objects, the control chip of the present invention includes: a processor, a timer, a plurality of GPIO pins, at least one programmable memory, wherein the programmable memory has a first firmware, the first firmware coded with a first boot program executable under normal conditions, and the at least one programmable memory further comprising a second firmware, the second firmware coded with a second boot program executable under an anomalous condition. Since the second boot program provides fewer functions than the first boot program, the memory required for the second firmware may be smaller than the memory required for the first firmware.

Furthermore, the present invention also provides a computer using the above-mentioned control chip, and the computer comprises a CPU, a memory, a screen, and the control chip.

The present invention further provides a method of executing a boot program in the above-mentioned control chip of a computer under abnormal conditions. The method comprises receiving an initialization procedure, the initialization procedure used to completely stop power to the control chip; detecting whether an anomalous-condition procedure is executing; if the anomalous-condition procedure is executing, executing the second boot program to start the computer; otherwise executing the first boot program.

With the firmware are arrangement of the above-mentioned keyboard control chip and the related method, the computer can execute the second boot program to repair or update the first boot program.

Other objects, advantages, and novel features of the invention will become more apparent from the following detailed description when taken in conjunction with the accompanying drawings.

### BRIEF DESCRIPTION OF THE DRAWINGS

FIG. 1 is a front view of a computer according to the present invention.

FIG. 2 is rear view of the computer according to the present invention.

FIG. 3 is a functional block drawing of the computer according to the present invention.

FIG. 4 is a schematic drawing of a keyboard control chip according to the present invention.

FIG. 5 is a schematic drawing of first firmware in a keyboard control chip according to the present invention.

FIG. 6 is a schematic drawing of second firmware in a keyboard control chip according to the present invention.

FIG. 7 is a flowchart of a boot procedure according to the present invention.

FIG. 8 is a flowchart of an anomalous condition in a first embodiment according to the present invention.

FIG. 9 is a flowchart of an anomalous condition in a second embodiment according to the present invention.

### DETAILED DESCRIPTION OF THE PREFERRED EMBODIMENT

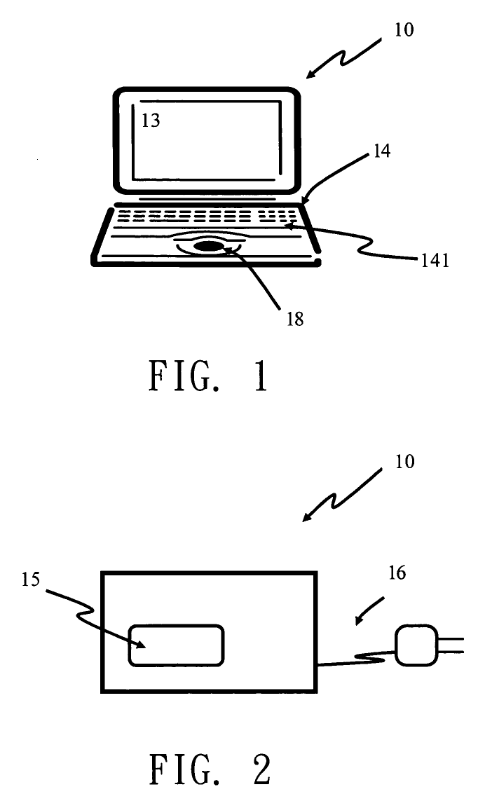

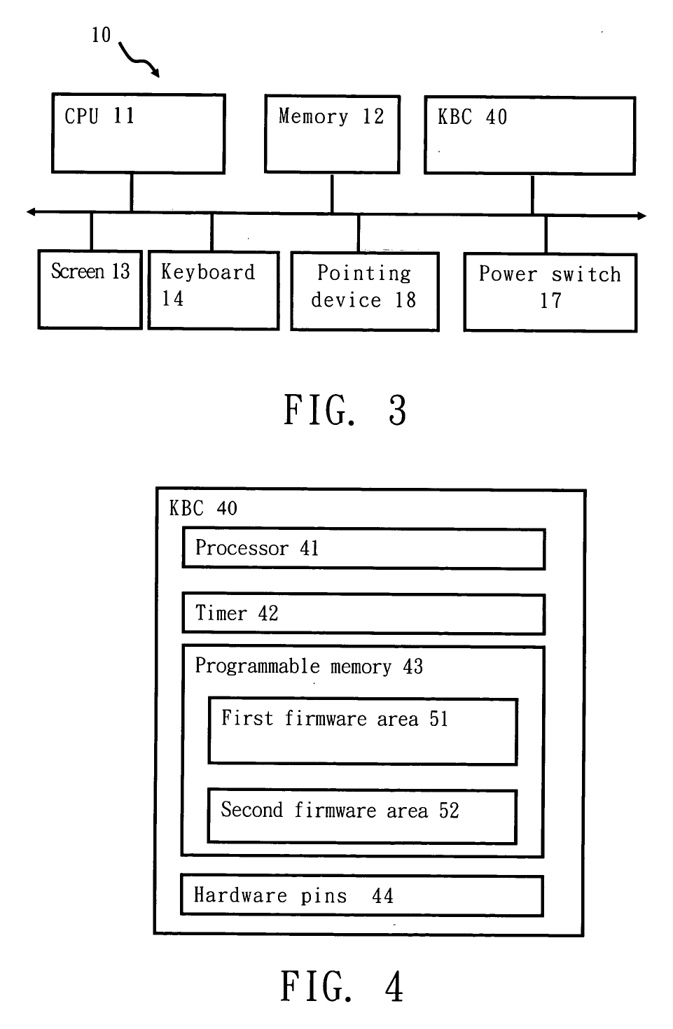

Please refer to FIG. 1 to FIG. 3 for the hardware structure of a computer. In this embodiment, the computer is a notebook computer, and a keyboard control chip 40 is used to control a boot procedure of the computer (of course, the control chip should not be construed as limited to keyboard control chips; for example, the control chip may be designed to receive boot signals from other devices, such as from a mouse). The following description simply uses the keyboard control chip 40 as an exemplary embodiment.

The computer 10 comprises a CPU 11, a memory 12, a screen 13, a keyboard 14, a power switch 17, a pointing device 18 (for controlling a cursor) and the keyboard control chip 40; the power source of the computer 10 may be a battery 15 or a power cable 16 connected to an external power supply, which is controlled by the power switch 17. A characteristic of the present invention is that when the computer 10 is unable to execute the boot procedure normally, for example due to firmware damage or production errors, the present invention provides an anomalous-condition boot procedure to repair the original system.

In order to achieve the above objective, the keyboard control chip 40 of the present invention provides an additional program area to execute the anomalous-condition boot procedure. Please refer to FIG. 4. FIG. 4 is a schematic drawing of a keyboard control chip according to the present invention. The keyboard control chip 40 comprises a processor 41, a timer 42, a plurality of GPIO pins 44 and at least one programmable memory 43. The processor 41 is used to execute various operational procedures in the keyboard control chip 40; the timer 42 keeps track of time, and the keyboard control chip 40 utilizes the GPIO pins 44 to connect to other hardware components and to transmit information. Since the processor 41, the timer 42 and the GPIO pins 44 are well known technologies, and are not characteristics of the present invention, they require no further description. The programmable memory 43 comprises a first firmware 51 and a second firmware 52. The first firmware 51 is used to execute a normal boot procedure for the computer 10; if the computer 10 has firmware update problems that cause the first firmware 51 to function abnormally, the second firmware 52 may be used to execute the anomalous-condition boot procedure for the computer 10 to repair the first firmware 51.

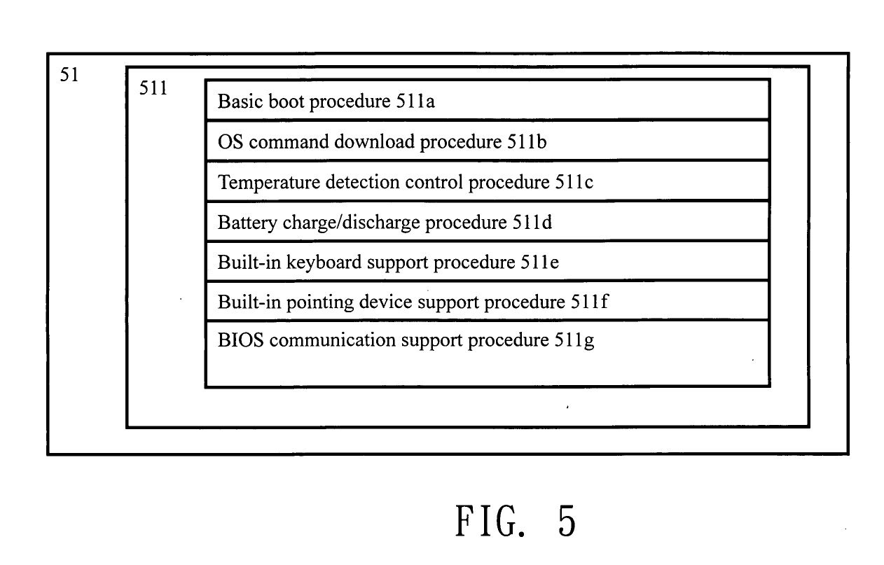

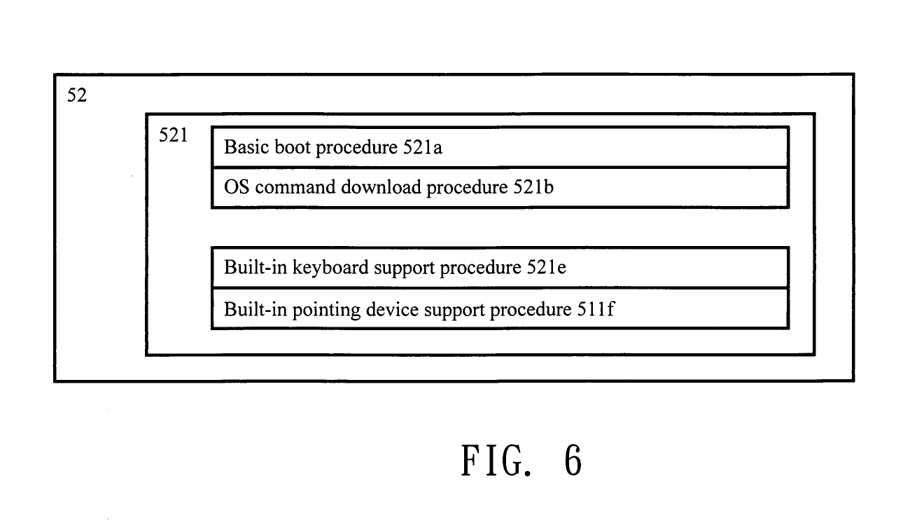

Please refer to FIG. 5 and FIG. 6. FIG. 5 is a schematic drawing of the first firmware in the keyboard control chip according to the present invention.

FIG. 6 is a schematic drawing of the second firmware in the keyboard control chip according to the present invention. The first firmware 51 is coded with a first boot program 511, which includes a basic boot procedure 511a, an OS command download procedure 511b, a temperature detection control procedure 511c, a battery charge/discharge procedure 511d, a built-in keyboard support procedure 511e, a built-in pointing device support procedure 511f and a BIOS communication support procedure 511g. The second firmware 52 is coded with a second boot program 521; when the first boot program 511 is unable to execute, or requires repair or updating, the second boot program 521 may be executed to update the first boot program 511. Therefore, the second boot program 521 only needs to include certain necessary procedures: a basic boot procedure 521a, an OS command download procedure 521b, a built-in keyboard support procedure 521e, and a built-in pointing device support procedure 521f. Since the second boot program 521 provides fewer functions than the first boot program 511, the memory required for the second firmware 52 may be smaller than the memory required for the first firmware 51. The second boot program 521 uses the basic boot procedure 521a to start the computer 10, and then uses the OS command download procedure 521b to burn, correct or modify the first boot program 511.

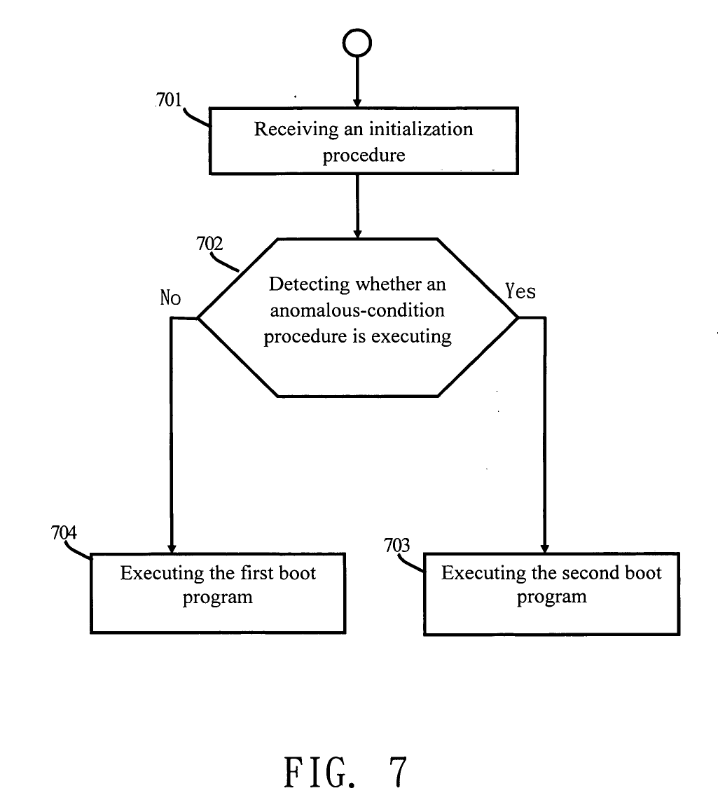

Please refer to FIG. 7. FIG. 7 is a flowchart of a boot procedure according to the present invention.

Step 701:

Receiving an initialization procedure; the initialization procedure completely stops providing power to the keyboard control chip 40. Taking the notebook computer 10 as an example, the battery 15 or the power cable 16 connected to the external power needs to be removed to initialize the keyboard control chip 40.

Step 702:

Detecting whether the anomalous-condition boot procedure is performed. A software program for this detection step can be stored in the second boot program 521 in the second firmware 52 and is executed by the processor 41.

The contents of the anomalous-condition boot procedure are described in steps 801˜step 802 in a first embodiment, and in steps 901˜step 902 in a second embodiment.

If the anomalous-condition boot procedure is performed, step 703 is executed; otherwise, step 704 is executed.

Step 703:

The second boot program 521 is used to start the computer.

Step 704:

The first boot program 511 is used to start the computer.

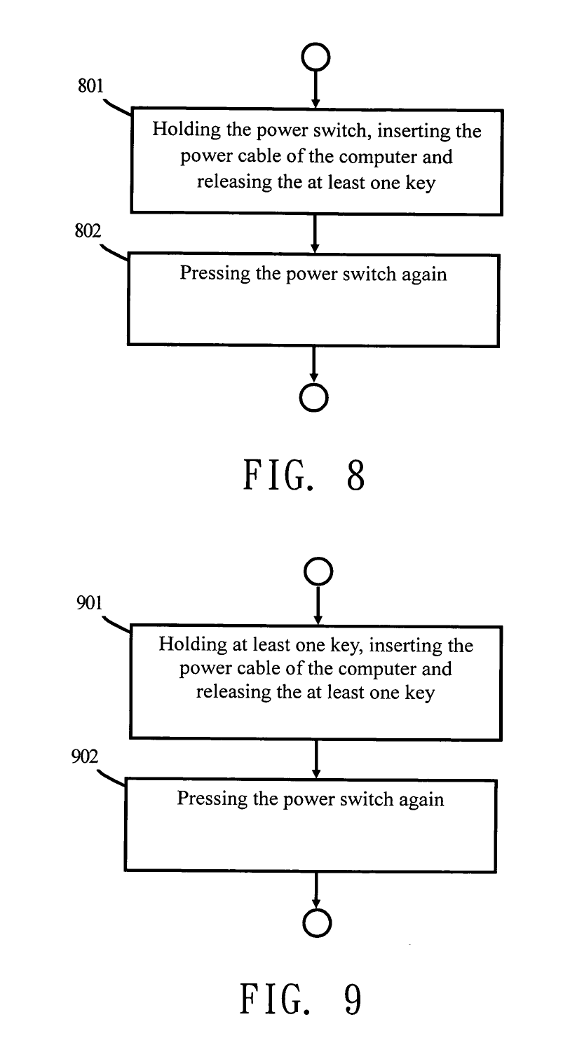

Please refer to FIG. 8. FIG. 8 is a flowchart of an anomalous-condition procedure in a first embodiment according to the present invention.

Step 801:

The power switch 17 is pressed and held, the power cable 16 is inserted, and then the power switch 17 is released.

First, a user must press and hold the power switch 17 of the computer 10, insert the battery 15 or the power cable 16 connected to external power, and continuously hold the power switch 17 for two or more seconds and then release the power switch 17; since the timer 42 provides time information, the software program can determine the required time period. The time period for continuously pressing the power switch 17 can be adjusted with software parameters, and need not be limited to two seconds. The purpose of continuously holding the power switch 17 for a predetermined period of time is to prevent the user from accidentally executing the second boot program 521.

Step 802:

The power switch 17 is pressed again.

This step can be skipped, as long as step 801 automatically turns on the power and step 703 continues. Step 802 is provided because most users prefer to manually turn on the power again.

Since the keyboard control chip 40 can detect power supply changes via the GPIO pins 44, when step 801 and step 802 detect unusual power supply changes, the processor 41 may execute the anomalous-condition boot procedure.

Please refer to FIG. 9. FIG. 9 is a flowchart for an anomalous condition procedure in a second embodiment according to the present invention.

Step 901:

Pressing and holding at least one key 141 on the keyboard 14 (i.e., for more than two seconds), inserting the power cable 16 and then releasing the at least one key 141 on the keyboard 14; step 901 is similar to step 801. The at least one key 141 may be a less-frequently used key, or more than one key 141 (i.e., pressing the “A”, “D”, and “G” keys together), to prevent the user from accidentally executing the second boot program.

Step 902:

The power switch 17 is again pressed.

As with step 802, step 902 may also be skipped.

Since the keyboard control chip 40 can detect power supply changes via the GPIO pins 44, when step 901 and step 902 detect unusual power supply changes, the processor 41 may execute the anomalous-condition boot procedure.

Although the present invention has been explained in relation to its preferred embodiment, it is to be understood that many other possible modifications and variations can be made without departing from the spirit and scope of the invention as hereinafter claimed.

What is claimed is:

1. A control chip for a computer boot procedure, the control chip comprising a processor, a timer, a plurality of GPIO pins, at least one programmable memory, wherein the processor is used for executing various procedures in the control chip, the timer is used for counting elapsed time, the plurality of pins connected to other hardware devices and used for information transmission, and the at least one programmable memory having a first firmware, the first firmware coded with a first boot program executable under normal conditions, and the at least one programmable memory further comprising a second firmware, the second firmware coded with a second boot program executable under an anomalous condition.

2. The control chip for the computer boot procedure as claimed in claim 1 further comprising a keyboard control chip.

3. The control chip for the computer boot procedure as claimed in claim 1, wherein the first boot program is capable of executing a basic boot procedure, an OS command download procedure, a temperature detection control procedure, a battery charge/discharge procedure, a built-in keyboard support procedure, a built-in pointing device support procedure and a BIOS communication support procedure.

4. The control chip for the computer boot procedure as claimed in claim 1, wherein the second boot program is capable of executing a basic boot procedure, and an OS command download procedure.

5. The control chip for the computer boot procedure as claimed in claim 1, wherein the second boot program is further capable of executing the built-in keyboard support procedure and the built-in pointing device support procedure.

6. The control chip for the computer boot procedure as claimed in claim 1, wherein an initialization procedure must be executed before execution of the second boot program, the initialization procedure including completely stopping supplying power to the control chip.

7. A computer comprising a CPU, a memory, a screen, and a control chip, the control chip comprising a processor, a timer, a plurality of GPIO pins, and at least one programmable memory, wherein the processor is used for executing various procedures in the control chip, the timer is used for counting elapsed time, the plurality of pins are connected to other hardware devices and used for information transmission, and the at least one programmable memory has a first firmware, the first firmware coded with a first boot program executable under normal conditions, and the at least one programmable memory further comprising a second firmware, the second firmware coded with a second boot program executable under an anomalous condition.

8. The computer as claimed in claim 7, wherein the control chip further comprises a keyboard control chip.

9. The computer as claimed in claim 7, wherein the first boot program is capable of executing a basic boot procedure, an OS command download procedure, a temperature detection control procedure, a battery charge/discharge procedure, a built-in keyboard support procedure, a built-in pointing device support procedure and a BIOS communication support procedure.

10. The computer as claimed in claim 7, wherein the second boot program is capable of executing a basic boot procedure, and an OS command download procedure.

11. The computer as claimed in claim 7, wherein the second boot program is capable of executing the built-in keyboard support procedure and the built-in pointing device support procedure.

12. The computer as claimed in claim 7, wherein an initialization procedure must be executed before execution of the second boot program, the initialization procedure including completely stopping supplying power to the control chip.

13. A method of executing a boot program in a control chip of a computer under abnormal-conditions, the control chip comprising a processor, a timer, a plurality of GPIO pins, and at least one programmable memory, wherein the at least one programmable memory has a first firmware and a second firmware, the first firmware coded with a first boot program, the second firmware coded with a second boot program, the first boot program executable under normal conditions, and when the first boot program fails, the control chip performs the following steps:
step A: receiving an initialization procedure, the initialization procedure used to completely stop power to the control chip;
step B: detecting whether an anomalous-condition procedure is executing; if the anomalous-condition procedure is executing, continuously performing step C; and
step C: executing the second boot program to start the computer.

14. The method as claimed in claim 13, wherein the control chip comprises a keyboard control chip.

15. The method as claimed in claim 13, wherein step A is achieved by removing all power sources from the computer.

16. The method as claimed in claim 15, wherein all power sources for the computer include a power cable of the computer or a battery.

17. The method as claimed in claim 13, wherein the anomalous-condition procedure in step B is achieved by the following steps: pressing a power switch of the computer, inserting the power cable of the computer and releasing the power switch.

18. The method as claimed in claim 17, wherein after releasing the power switch, a step of pressing the power switch again is included.

19. The method as claimed in claim 13, wherein the anomalous-condition procedure in step B is achieved by the following steps: holding at least one key on the keyboard, inserting the power cable of the computer and releasing the at least one key.

20. The method as claimed in claim 19, wherein after releasing the at least one key, a step of pressing the power switch again is included.
